(19) United States
(12) Patent Application Publication
(10) Pub. No.: US 2005/0231387 A1
(43) Pub. Date: Oct. 20, 2005

(54) Railroad crossing monitoring and citation system

(76) Inventor: Paul H. Markelz, West Chicago, IL (US)

Correspondence Address: QUARLES & BRADY LLP, 411 E. WISCONSIN AVENUE, SUITE 2040, MILWAUKEE, WI, 53202-4497, US

(21) Appl. No.: 10/828,426

(22) Filed: Apr. 20, 2004

(51) Int. Cl. G08G 1/017

(52) U.S. Cl. 340/937; 348/149

(57) ABSTRACT

A method and apparatus for monitoring vehicle violations at a railroad crossing, the method comprising the steps of providing a video camera at the crossing, using a processor to monitor information from the railroad crossing to determine when a traffic violation has likely occurred and when a violation has likely occurred, presenting video of the violation occurring to a system operator via a display screen, providing an input interface for the operator to confirm that a violation has occurred and when the operator confirms that a violation has occurred via the interface, at least one of generating a citation and storing a video clip of the violation for subsequent use.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The field of the invention is traffic monitors and more specifically railroad crossing monitors, confirming methods and automatic citation generators.

One of the most challenging problems facing railroads today is how to deal with ever increasing numbers of railroad crossing traffic violations. Monitoring of crossings in congested residential areas has shown that many violations occur daily that could potentially lead to accidents and/or damage to regulating equipment located at railroad crossings (i.e., broken crossing gates/motors, etc.). When an accident occurs costs are appreciable including damage to trains and involved vehicles and possible injury to persons on the train, to the person that commits the violations and to other people within the general vicinity of the accident (i.e. pedestrians near an intersection, drivers in vehicles proximate the intersection, etc. Moreover, even relatively small rail road accidents typically result in at least some and in many cases, extensive damage to property adjacent the track on which the accident occurs.

In addition to property and personal damage, accidents typically result in bottlenecking effects as trains “stack up” in a queue and have to be re-routed around crossings where accidents have occurred. Similarly, many municipal codes require railroad traffic through crossings where regulating equipment has been damaged to be halted until the regulating equipment is fixed which results in stacked up trains and re-routing requirements. While railroad companies attempt to minimize the effects of accidents and halted traffic by cleaning up accidents and fixing damaged equipment quickly, accidents and damaged equipment nevertheless reduce profits appreciably when they occur.

One way to reduce traffic violations is to enforce traffic laws more effectively. Recently video enhanced systems for monitoring traffic have been developed. Unfortunately, one problem with existing video enhanced monitoring systems is that many municipalities require actual real time verification of violations by a human being in order for associated traffic violation citations to be upheld. Thus, for instance, if a police officer personally witnesses a railroad crossing violation, a citation issued by the officer will be upheld under most municipal codes while a citation issued either automatically via a processor based system or manually by an officer some time after a violation occurs pursuant to examination of a video of the violation often is not enforceable. Hereinafter code requirements that a witness must observe a violation in real time for a citation to be upheld will be referred to as “witness requirements”.

One solution to the problem posed by witness requirements in municipal codes is to station officers or railroad employees at each railroad crossing around the clock so that violations can be personally verified. While this solution would solve the problem, obviously this solution is far too expensive to be useful in essentially all applications. In addition to the costs associated with employing officers stationed at each crossing, someone would also have to be employed to fill out and mail citations which is typically a time consuming and relatively boring task.

Another solution to the problem posed by witness requirements in at least some jurisdictions that do not require a real time witness (i.e., a witness that observes a violation as the violation is occurring) is to provide cameras at crossings to generate videos of violations and subsequently either automatically or manually review the videos to identify violations and issue citations. Unfortunately this solution is not available in most jurisdictions which require real time witnesses to sustain citations and, even where this solution is available, the time and effort required to review video to confirm violations and then to generate citations often renders such systems impractical.

Thus, there is a need for a simplified system that can facilitate real time monitoring of traffic violations at a plurality of railroad crossings by a minimal number of system operators, and that confirms real time observation of violations that occur that streamlines the violation identifying and citation generating processes.

### BRIEF SUMMARY OF THE INVENTION

It has been recognized that cameras, processors and other technology can be assembled to construct a system that enables a remote system operator to monitor many intersections at the same time and to witness intersection and railroad violations as they occur and essentially in real time. To this end, generally, a processor may be programmed to examine many different and simultaneous video clips from many different intersections and, when a violation is likely occurring, to present the violation to the operator via a large window display while also calling the operator's attention to the window via an audible or visual alarm device.

In addition, when a violation likely occurs, corroborating evidence that the operator witnessed the violation via a video may be generated such as, for instance, recordation of the time at which the operator began to observe the video clip, a video clip of the operator observing the video of the violation, etc. Moreover, corroborating evidence of the violation in the form of the video of the violation may be generated, stored and rendered accessible in various ways. Furthermore, the system may be programmed to automatically generate a citation and to enable the operator to confirm that a violation has occurred and that a citation should be issued.

Consistent with the above, at least some embodiments of the present invention include a method for monitoring vehicle violations at a railroad crossing, the method comprising the steps of providing a first video camera at the crossing, using a processor to monitor information from the railroad crossing to determine when a traffic violation has likely occurred and when a violation has likely occurred, presenting video of the violation occurring to a system operator via a display screen providing an input interface for the operator to confirm that a violation has occurred and when the operator confirms that a violation has occurred via the interface, at least one of generating a citation and storing a video clip of the violation for subsequent use.

The invention also includes a method for monitoring vehicle violations at a location, the method comprising the steps of specifying a traffic violation that may occur at the location, providing a video camera at the location, using a processor to monitor information from the location to determine when a traffic violation has likely occurred and when a violation has likely occurred, presenting video of the violation occurring to a system operator.

In addition, at least some embodiments of the invention include an assembly for monitoring vehicle violations at a railroad crossing, the assembly comprising a video camera at the crossing, a video display screen, an input interface, a processor receiving information from the railroad crossing and programmed to perform the steps of determining when a traffic violation has likely occurred, when a violation has likely occurred, presenting video from the camera of the violation occurring to a system operator via the display screen and monitoring the input interface for an indication confirming that a violation has occurred.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a top plan schematic view of an exemplary roadway-railway intersection including various hardware components consistent with at least some aspects of the present invention;

FIG. 2 is a schematic diagram of the exemplary workstation of FIG. 1;

FIG. 3 is a perspective view of an interface in two different states or at two different time according to at least one embodiment of the present invention;

FIG. 4 is a screen shot that may be provided via the interface of FIG. 3 showing an exemplary image of a citation and interface icons;

FIG. 5 is a flow chart illustrating one method according to at least some aspects of the present invention;

FIG. 6 is a flow chart illustrating another method according to at least some aspects of the present invention; and

FIG. 7 is a flow chart illustrating yet another method according to at least some aspects of the present invention

### DETAILED DESCRIPTION OF THE INVENTION

While the present invention may be embodied in any of several different forms, the present invention is described here with the understanding that the present disclosure is to be considered as setting forth an exemplification of the present invention which is not intended to limit the invention to the specific embodiment(s) illustrated and described.

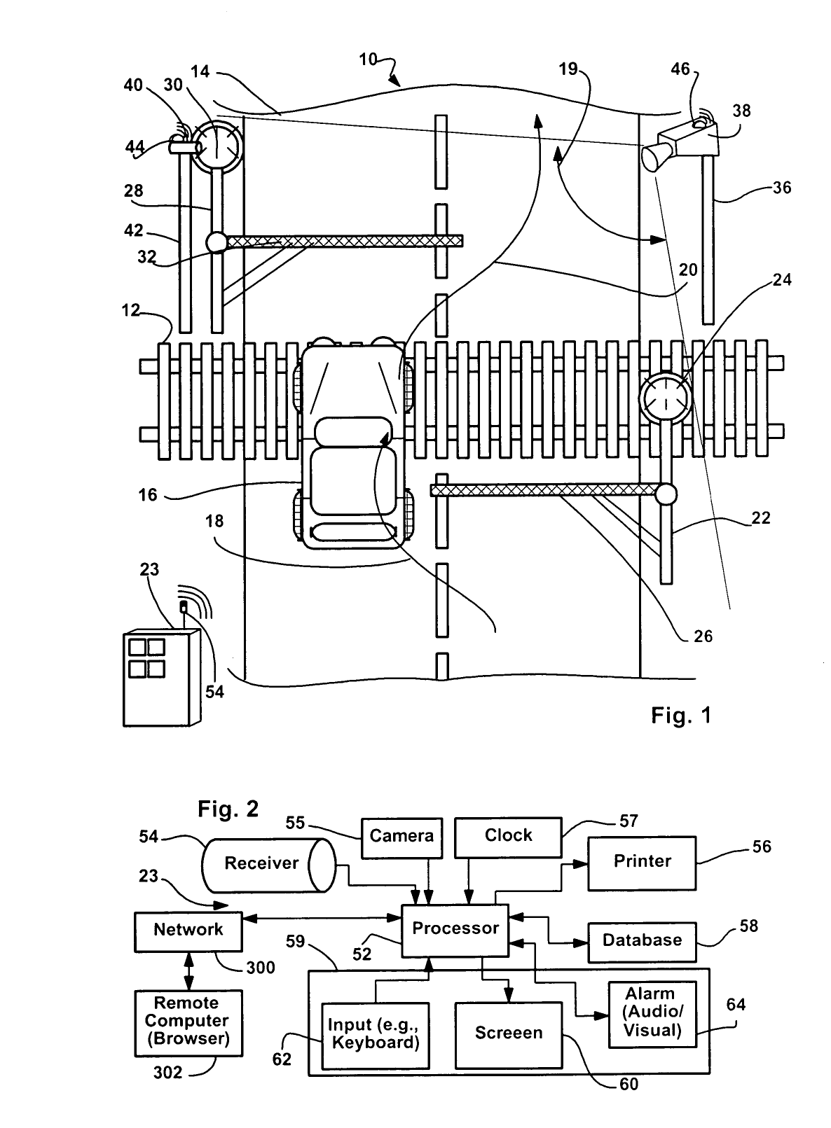

Referring now to the drawings wherein like reference numerals correspond to similar elements throughout the several views and, more specifically, referring to FIG. 1, the present invention will be described in the context of an exemplary roadway-railway intersection 10. Intersection 10 comprises the intersection of a two-way road including a south bound lane 14s and a north bound lane 14n and a single lane railway track identified by numeral 12. Conventional equipment provided at intersection 10 includes components to signal when a train is approaching intersection 10 as well as to indicate when a train is passing through intersection 10. In addition, gates for halting traffic when a train is approaching or passing through intersection 10 are provided. In FIG. 1, a north bound gate for halting north bound traffic is identified by numeral 26 and a south bound gate for halting south bound traffic is identified by numeral 32. Gate 26 is mounted on a post 22 and is movable between an upright vertical position (not illustrated) and a substantially horizontal traffic halting position where gate 26 extends substantially across north bound lane 14n. Similarly, south bound gate 32 is mounted to a post 28 for movement between a vertical position (not illustrated) and a substantially horizontal position where gate 32 extends substantially across the entire width of south bound lane 14s.

Referring still to FIG. 1, at the top of each of posts 22 and 28, signaling lights 24 and 30, respectively, are supported which flash on and off to indicate that a train is approaching or is passing through intersection 10. In addition, a bell or other type of audible signaling device (not illustrated) may be provided proximate intersection 10 (e.g., on one or both of posts 22 and 28) to signal an approaching or present train. Although not illustrated, sensors are provided along lengths of track 12 adjacent (e.g., ¼ mile down the railway) the illustrated track section for sensing when at train is approaching intersection 10. Once a train is sensed, a controller (not illustrated) flashes lights 24 and 30 on and off indicating that a train is approaching. A short time thereafter, gates 26 and 32 are lowered to halt traffic through intersection 10.

Referring yet again to FIG. 1, an automobile is represented by element 16 which is intended to illustrate a traffic violation as the violation is occurring. Here, it is assumed that vehicle 16 was initially in the north bound lane 14n and that, after gates 26 and 32 were lowered, the driver of vehicle 16 decided to swerve into south bound lane 14s and between gates 26 and 32 back into north bound lane 14n passing over track 12 prior to the train passing through intersection 10 as indicated by arrows 18 and 20.

Referring once again to FIG. 1, a wide angle camera 38 is mounted on top of a post 36 proximate intersection 10 and such that the camera lens is directed toward intersection 10 and can collect video of activities that take place at intersection 10. Here, while a single camera 38 including a lens having a wide angle 19 is illustrated in FIG. 1, it should be appreciated that, in at least some embodiments of the present invention, two or more cameras may be stationed at an intersection for collecting video of occurrences that take place there. The number and juxtaposition of cameras at intersection 10 will be a function of the complexity of the intersection as well as designer choice.

Camera 38 includes a transceiver 46 that is capable of transmitting video to a remote station 23 in real time. In addition, transceiver 46, in at least some embodiments, will be capable of receiving signals from other system components and using those signals to either perform system processes or passing those signals on to remote station 32. For instance, where two or more cameras are located at an intersection 10, one of the cameras may transmit video to the other of the cameras and the receiving camera may transmit video from that camera as well as the other camera at intersection 10 to a remote location.

In addition to camera 38, at least some embodiments of the present invention will include a dedicated sensor that is independent of preexisting intersection components for sensing when a train is approaching intersection 10. To this end, because of liability concerns, it is contemplated that most railroad company's that maintain railroad crossing warning and traffic control systems will not allow third parties to tie into their train sensing or traffic halting systems which could lead to failure of primary signaling and halting components. In at least some embodiments of the invention, the additional dedicated sensor for determining when a train is approaching intersection 10 may include a separate sensor located along a portion of track 12 adjacent the illustrated portion. In the alternative, as illustrated in FIG. 1, a light sensor 40 may be mounted at the top of a post 42 for sensing light generated when light 30 flashes on and off. In either of the above cases, the sensor for sensing when a train is approaching intersection 10 is totally independent and separate from preexisting signaling and halting systems and therefore should not affect operability thereof. In FIG. 1, sensor 40 is provided with a transmitter 44 for transmitting signals to transceiver 46 on camera 38.

In some embodiments it is contemplated that camera 38 will record and transmit video of intersection 10 virtually all the time. In other embodiments, it is contemplated that camera 38 will be turned on and remain on only once sensor 40 senses that a train is approaching intersection 10 and transmits a signal to camera 38 and for a short duration after a train leaves intersection 10. In still other embodiments, camera 38 may be turned on and record and transmit video only during periods when a train is entering or leaving intersection 10 to record traffic violations.

Referring yet again to FIG. 1, remote operator's station or work station 23 includes a receiver 54 for receiving signals from camera 38. Station 23 may be near intersection 10 or, as in the case in at least some contemplated embodiments, may be several miles away from intersection 10.

Referring now to FIG. 2, system components that may be included at work station 23 are illustrated and include, in addition to receiver 54, a processor 52, a camera 55, a clock 57, a printer 56, a database 58 and an interface 59 including, in at least some embodiments, an alarm 64, a screen 60 and an input device 62. In some embodiments processor 52 may be linked via a network (e.g., the Internet) 300 to remote computers 302 or work stations to so that citations and other information (e.g., video clips) can be broadcast to interested parties (e.g., violators). Processor 52 is linked to each of the other components identified above and runs software for carrying out various methods according to the present invention. Generally, processor 52 is programmed to recognize when traffic violations occur at intersection 10 and to perform some secondary process thereafter. To this end, in at least some embodiments, processor 52 may be programmed to use a signal from sensor 44 and video from camera 38 to determine when a vehicle (e.g., 16 in FIG. 1) is passing through intersection 10 after lights 24 and 30 have begun to flash. Software for recognizing occurrences within video is well known in various arts and therefore will not be described here in detail.

In some embodiments, processor 52 is programmed to, when a violation occurs, provide video of the violation as the violation is occurring via screen 60 so that an operator can independently confirm that a violation has occurred. When processor 52 initially identifies that a violation may be occurring at intersection 10, processor 52 may be programmed to activate either an audible or visual alarm or both proximate screen 60 thereby calling an operators attention to screen 60 so that the violation occurring can be observed in real time. In some cases processor 52 will be programmed to, after video of a violation is commenced on screen 60, monitor input device 62 for an indication that the system operator is observing the real time video and may store the time at which the indication is provided. In addition, processor 52 will, in at least some cases, be programmed to monitor input 62 for an indication that the system operator is confirming that a violation has occurred or for an indication that the operator is rejecting the occurrence as a violation. Where a violation has occurred and is confirmed by an operator, processor 52 may be programmed to store the video of the violation in database 58 for future use.

In addition, when a violation has been confirmed, processor 52 may be programmed to generate and present an image of a citation associated with the violation via screen 60 for the operator to confirm or reject. Here, it is contemplated that processor 52 will be programmed to fill out essentially all of the information required on a citation form including the date, time at which an infraction has occurred, time at which an operator confirmed that the operator was watching the video, the license plate number of the vehicle in which a violation occurred, the identity of the operator, the amount of a fine and corroborating evidence that an infraction occurred as well as other information. Software already exists for automatically identifying license plate numbers via remote cameras and therefore the complexities of that type of software are not described here in detail. In addition to the information above, processor 52 may be linked into a database that correlates license plate numbers with vehicle owner information and the owner information may be accessed and added to the citation automatically. To identify the time of infraction and the time at which an operator confirms that a video is being watched, processor 52 is linked to clock 57.

After a citation has been posted on screen 60, processor 52 may provide options to the operator enabling the operator to confirm or reject issuance of the citation and/or to edit the information on the citation. When an operator confirms that a citation should be issued, processor 52 prints the citation via printer 56 and may be programmed to automatically cause the citation to be mailed.

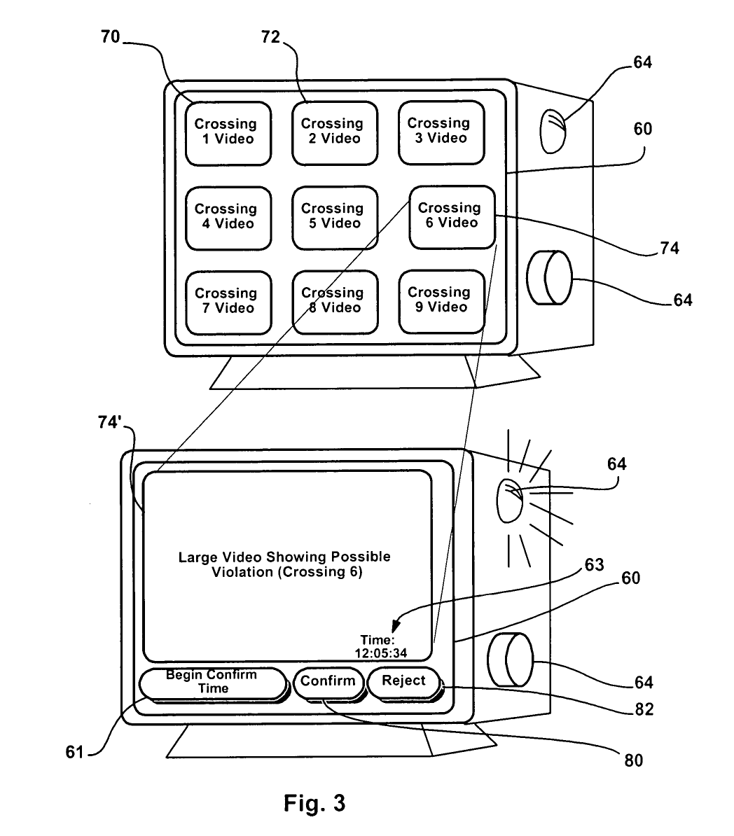

Referring now to FIG. 3, an exemplary interface 59 including a screen 60 and audible and visual alarm devices 64 is illustrated in two different states at two different times. In the first state which appears at the top of FIG. 3, screen 60 is divided into nine separate small windows, three of which are identified by numeral 70, 72 and 74. Here it is contemplated that systems like the system illustrated in FIG. 1 may be provided at a plurality of different intersections and a single operator work station 23 may be used to monitor all of the separate intersections. In this case, when a likely violation is identified at a specific one of the crossings being monitored by the work station 23, processor 52 automatically increases the size of the window corresponding to the intersection at which the violation is likely occurring so that the video of the violation is presented in a much large format as illustrated in the interface at the bottom of FIG. 3. For instance, when a violation is likely occurring at intersection or crossing 6, the smaller window 74 displaying video of crossing 6 is increased so that a larger window 74′ is provided on screen 60. Processor 52 provides the time 63 in the lower right hand corner of window 74′.

In addition to providing large window 74′ on screen 60 when a violation is likely occurring, processor 52, in at least some embodiments, also provides various touch selectable icons (i.e., input devices) below window 74′. In at least some embodiments, the touch selectable icons include a begin confirm time icon 61, a confirm icon 80 and a reject icon 82. As its label implies, the begin confirm time icon 61 is selectable by a system operator to indicate the time at which the operator begins to observe the video in window 74′. Thus, for instance, where processor 52 begins to show video of a violation occurring at 5 minutes and 34 seconds after mid-night, if it takes the operator 3 seconds to select icon 61, the time of video confirmation will be 5 minutes and 37 seconds after mid-night. When icon 61 is selected, processor 52 stores the time associated therewith. After viewing a video of a likely violation one or more times via window 74′, the system operator may select confirm icon 80 thereby indicating that in fact a violation at crossing 6 has occurred. If, after viewing the video, the operator decides that a violation did not occur for some reason, the operator may select reject icon 82 after which processor 52 erases all information including times and video, corresponding to the rejected occurrence.

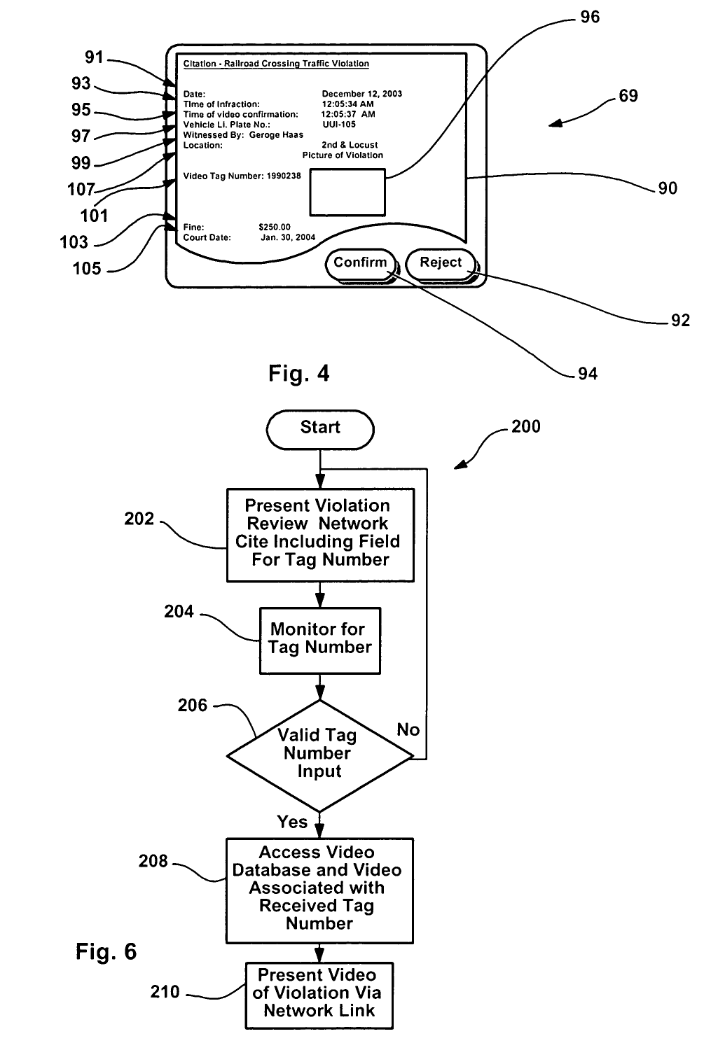

Referring now to FIG. 4, an exemplary interface screen shot showing an exemplary citation displayed on screen 60 is illustrated. The citation screen shot 69 shows an automatically instantiated citation including essentially all of the information necessary to issue a citation. To this end, the exemplary citation includes a date 91, the time of the infraction 93, the time of video confirmation by the operator 95, the vehicle license plate number 97, the operator's identity 99, the location of the infraction 107, the amount of a fine 103 and a court date 105. In addition, evidence corroborating that an infraction or traffic violation has occurred may be provided on the citation including a picture 96 of the violation as the violation was occurring as well as a video tag number 101 which may be used to access video corresponding to the violation via the internet as described in greater detail below.

In addition to an image of the citation, screen shot 69 also includes touch selectable confirm and reject icons 94 and 92, respectively, for indicating that a citation should be issued or rejected, respectively. Where confirm icon 94 is selected, processor 52 prints the citation via printer 56 for mailing. Where the citation is rejected by selection of icon 92, processor 52 erases the citation information from database 58. In some embodiments, although not illustrated, an edit icon may also be provided to allow the operator to access citation editing tools.

Where processor 52 has access to a database that correlates license numbers and e-mail addresses, processor 52 may e-mail the citation to the owner of a vehicle used to commit the traffic violation instead of printing the citation for conventional mailing. In the alternative, a system operator may manually identify a license number from a video and may manually access a database to identify a vehicle owner's e-mail address to electronically send a notice or citation. Where a citation is e-mailed to a vehicle owner via a network 300, the unique video tag number (see again 101 in FIG. 4) may be highlighted and hyperlinked to the video clip showing the violation. When the vehicle owner accesses the citation via a remote computer 302, the owner can observe the citation and confirm the violation. It has been recognized that, in many cases, vehicle drivers that violate traffic rules are strongly inclined to pay fines as opposed to fighting a citation when faced with video that confirms that a violation has occurred. In the above e-mail example, vehicle owners can quickly, easily and privately observe a violation and determine how to respond. In addition, an e-mail citation may include instructions/tools for how to pay the fine via the Internet or the like using a credit card number or the like.

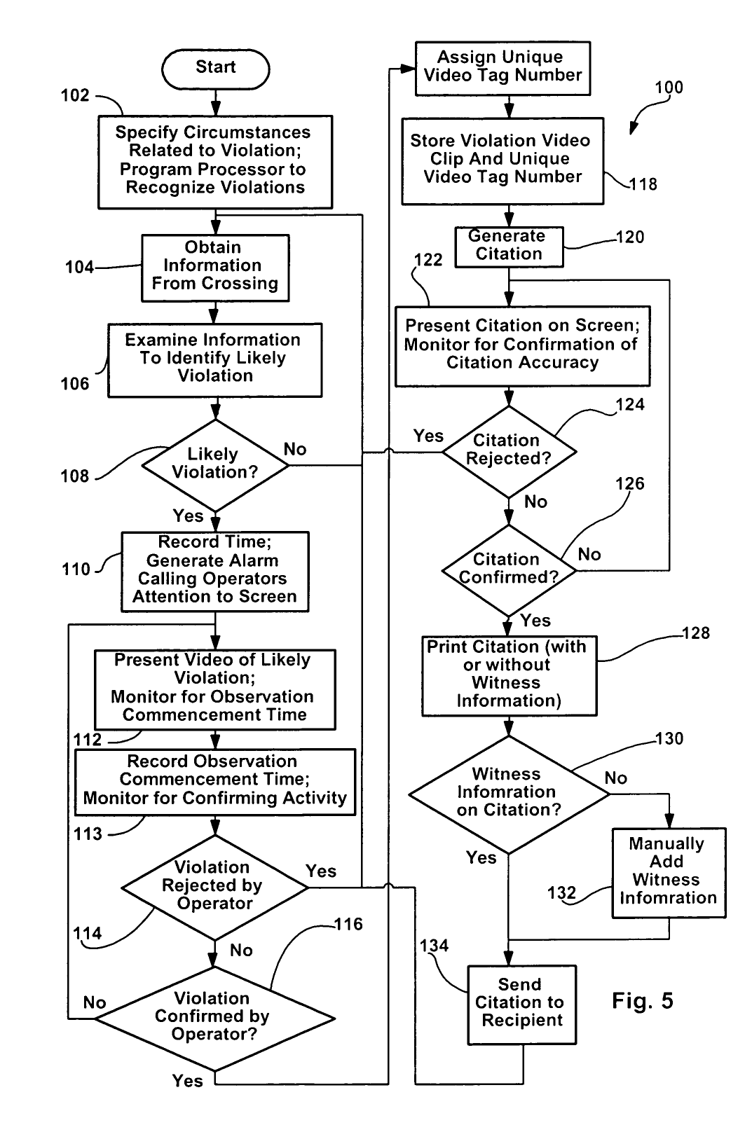

Referring now to FIG. 5, an exemplary method 100 according to at least some aspects of the present invention and consistent with the comments above is illustrated. Beginning at block 102, a system programmer specifies circumstances related to violations that may occur at each of the intersections to be monitored by an operator working at workstation 23. In addition, the programmer programs processor 52 to recognize violations specified. Here, processor 52 may recognize a likely violation by, after light is sensed by sensor 40, identifying a vehicle within the space between posts 22 and 28 in FIG. 1. Any manner of programming pattern recognition may be used with the present invention and the invention should not be limited by which programming process is employed.

Referring also to FIGS. 1 and 2, at block 104, information is obtained from each of the crossings being monitored by the operator. Here, the information obtained may include information from sensors like sensor 40 as well as video information from camera 38.

At block 106, processor 52 examines the information received to identify likely violations. Where violations have not occurred, control loops from block 108 back up to block 104 where the process including block 104 and 106 is repeated. At block 108, when a violation has likely occurred, referring also to FIG. 3, processor 52 activates the visual alarm 64 and/or the audible alarm 64 thereby calling an operators attention to screen 60. At block 112, processor 52 presents video of the likely violation as the violation is occurring. In addition, at block 112, processor 52 monitors the interface for selection of the begin confirm time icon 61 which confirms that an operator is observing the video being presented. At block 113, after icon 61 has been selected, processor 52 records the observation commencement time and begins to monitor the interface for an indication from the operator that in fact the occurrence at the intersection amounts a violation.

Here, it is contemplated that the enforcing authority (i.e., the entity maintaining the monitoring system and issuing citations) will develop clear guidelines for the system operator to follow when determining whether or not to issue a citation. To this end, most municipal codes allow citations to be issued in the context of a rail road crossing violation whenever a vehicle enters the intersection while the signaling lights are flashing despite the positions of the crossing gates. Thus, in some cases the guidelines may require that an operator confirm a violation and issue a citation whenever the lights are flashing and a vehicle enters the intersection. In other cases the guidelines may give drivers some leeway and only require a citation to be issued if a vehicle is within the intersection after the gates have begun to rotate downward into their blocking positions or after the gates have reached their horizontal blocking positions. Other guidelines are contemplated for use at rail road intersections as well as at other types of traffic intersections and roadway structures and the present invention should not be limited by the guidelines employed.

Continuing, at block 114, where the operator rejects the occurrence as a violation, control loops back up to block 104 where the steps described above are repeated. At block 116, where an operator has confirmed a violation, control passes to block 169. At blocks 114 and 116, if the operator has yet to confirm or reject the occurrence as a violation, control loops back up block 112 where the video of the likely violation is repeated.

Next, at block 169, according to at least some embodiments of the present invention, a unique video tag number is assigned to the video clip associated with the confirmed violation. Continuing, at block 118, the video and unique tag number are stored in database 58 for subsequent use. At block 120, processor 52 generates an image of an instantiated citation. At block 122, processor 52 presents the citation image via screen 60 as illustrated in FIG. 4. At block 124, if the citation is rejected by selection of icon 92, control passes to block 104 where the process described above is repeated. At block 126, where icon 94 is selected and therefore the citation is confirmed, control passes to block 128. Where the presented citation has not been rejected or confirmed at blocks 124 and 126, control passes back up to block 122 where processor 52 continues to present the image of the citation for examination by the system operator.

At block 128, after the system operator indicates that a citation should be issued, processor 52 prints the citation via printer 56. In some cases, as illustrated in FIG. 4, witness or operator information will be identified on the citation while in other cases, that information will not be identified on the citation but may be added manually thereafter by the operator (e.g., a signature). In FIG. 5, where witness information is not provided on the citation, control passes to block 132 where the witness or operator manually adds identifying information after which control passes to block 134. Where witness information has been provided on the citation at block 130, control passes to block 134. At block 134, the citation is either manually or automatically (e.g., via e-mail) mailed to the owner of the vehicle in which the traffic violation was committed. After block 134, control again passes back up to block 104 where the process is repeated.

According to another aspect of the present invention, it is contemplated that a system may be developed to allow persons receiving citations via the mail (e.g., hard copy citations) to privately and easily access video clips of the violations. Here, again, the idea is to encourage violators to pay fines via corroborating and indisputable evidence. To this end, in at least some embodiments of the invention, the unique video tag number associated with video of a traffic violation maybe be used via a computer network such as the Internet to enable traffic violators to obtain access to video evidence corroborating that a violation has occurred. In this regard, a method 200 for providing video evidence to traffic violators is illustrated in FIG. 6. At block 202, a violation review network cite is provided via the Internet or the like that is accessible to traffic violators. Here, for instance, a municipality may provide a traffic violation web link on a home page for violators to use. When the link is selected, it is contemplated that instructions for gaining access to traffic violations may be presented including a field for entering the unique video tag number 101 (see again FIG. 4) that appears on the traffic citation received by the violator.

At block 204, a server monitors the tag number field for a valid video tag number. At block 206, where a valid tag number has not been entered by a violator, control passes back up to block 202 and the loop described above is repeated. After a valid tag number has been entered at block 206, control passes to block 208 where the server accesses the video database and video associated with the received tag number. At block 210, the server presents the video of the violation to the violator via the network link.

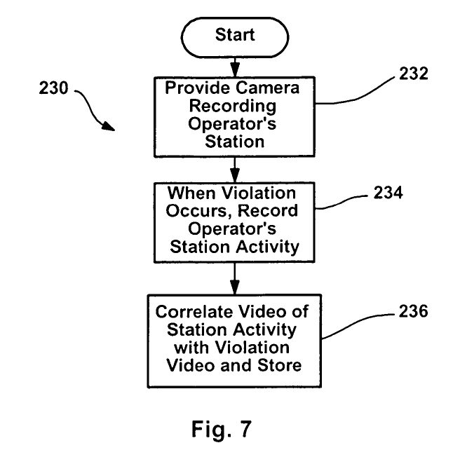

In order to provide additional evidence verifying that a system operator observes likely traffic violations via screen 60 as they occur, in at least some inventive embodiments, a second camera 55 (see again FIG. 2) may be provided that monitors the operator's workstation and, specifically, the location and orientation of the operator with respect to screen 60 as a violation is occurring. Here, processor 52 may, when a violation has been confirmed, store video from the intersection camera 38 as well as video from second camera 55 in an associated fashion for subsequent use. To this end, a corroborating method 230 including an operator workstation camera is shown in FIG. 7. At block 232, the second camera 55 is provided at the operator's station for recording activities thereat. At block 234, when a violation at an intersection 10 occurs, processor 52 records activities at the operator's station via camera 55. At block 236, the video of the station activity is correlated with the violation video and both videos are stored in database 58. Here, if necessary, the associated videos can be used to prove that an operator witnessed a violation as the violation was occurring.

From the foregoing, it will be observed that numerous modifications and variations can be effected without departing from the true spirit and scope of the novel concept of the present invention. It will be appreciated that the present disclosure is intended as an exemplification of the invention, and is not intended to limit the invention to the specific embodiment illustrated. The disclosure is intended to cover by the appended claims all such modifications as fall within the scope of the claims.

For example, in at least some embodiments, camera 38 may be able to collect image data including data from which the state (flashing or not flashing) of one or more of lights 30 and 24 can be determined such that sensor 40 or other sensors for sensing when lights 24 and 30 are flashing or when a train is approaching intersection 10 are not necessary. In addition, in at least some embodiments, instead of camera 38 including a wireless transceiver 46, in at least some cases camera 38 may be hardwired for providing information to processor 52. Moreover, in at least some cases some of the corroborating information may not be necessary or provided on a citation including, a time of operator video confirmation, a video tag number, a picture of the violation and so on.

Furthermore, in cases where two or more cameras are located at a single intersection and each camera generates video of a violation at the same time, processor 52 may present a split screen showing the violation as the violation occurs from two or more vantage points simultaneously and essentially in real time. Similarly, where violations occur simultaneously at two separate intersections, processor 52 may present a split screen to show both violations essentially in real time.

In addition, where an operator is reviewing citation information via display 60, if a violation occurs at a monitored intersection, processor 60 may be programmed to temporarily store the citation image and to present the video of the violation in real time. Here the citation image could be reaccessed subsequently.

Moreover, while the invention is described above in the context of a railroad crossing many of the concepts disclosed herein are applicable to other types of intersections as well as other types of traffic violations.

To apprise the public of the scope of this invention, the following claims are made:

1. A method for monitoring vehicle violations at a railroad crossing, the method comprising the steps of:
providing a first video camera at the crossing;
using a processor to monitor information from the railroad crossing to determine when a traffic violation has likely occurred; and
when a violation has likely occurred, presenting video of the violation occurring to a system operator via a display screen;
providing an input interface for the operator to confirm that a violation has occurred; and
when the operator confirms that a violation has occurred via the interface, at least one of generating a citation and storing a video clip of the violation for subsequent use.

2. The method of claim 1 wherein crossing control equipment is provided at the railroad crossing and the step of using a processor to monitor includes determining when a vehicle passes through the railroad crossing after the control equipment has indicated that traffic therethrough should cease.

3. The method of claim 1 wherein the step of at least one of generating and storing includes both generating and storing.

4. The method of claim 1 wherein the step of providing an input interface includes providing a single selectable button that indicates confirmation and monitoring the button for selection.

5. The method of claim 1 further including the step of, after video of a violation is commenced, monitoring the input interface for an indication that the operator is observing the video.

6. The method of claim 5 further including the steps of recording the time and duration of the violation as well as the time at which an operator indicates that the operator starts observing a video.

7. The method of claim 6 wherein the step of generating a citation includes printing on the citation the time at which a violation commenced and the time at which the operator indicated that the operator commenced observing the violation via the display.

8. The method of claim 7 wherein the step of generating a citation further includes printing on the citation the duration of the violation.

9. The method of claim 3 wherein the step of storing a video of a violation includes correlating the video with a unique tag number and storing the correlated tag number and video in a database and wherein the step of genrating a citation includes printing the tag number on the citation.

10. The method of claim 9 further including the step of providing a computer network cite for reviewing violation videos and, when the cite is accessed and a specific video tag number is entered, replaying the video via the computer network.

11. The method of claim 1 wherein the display and the input interface are provided at an operator's workstation and wherein the method further includes the steps of providing a second video camera at the operator's station to record the operator's activities as well as the images presented on the display and temporally correlating video from the first and second cameras.

12. The method of claim 4 wherein the step of generating a citation includes indicating the identity of the confirming operator on the citation.

13. The method of claim 1 wherein the step of providing a video camera at the railroad crossing includes providing a video camera at each of the plurality of railroad crossings, the step of using a processor to monitor information from the crossing to determine when a traffic violation has likely occurred includes using a processor to monitor information from each of the plurality of crossings and, the step of presenting video includes the step of, when a violation has likely occurred at any of the plurality of locations, presenting video of the violation occurring to a system operator.

14. The method of claim 1 wherein the processor is linked to a license-network address database, the method further including the step of, when a violation occurs, identifying the license plate number of a vehicle in which the violation occurred, using the license plate number and the database to identify the vehicle owner's network address and issuing a notice of the violation to the vehicle owner via the network address.

15. The method of claim 14 further including the step of, when the notice is issued, providing a link within the notice that enables the owner to hyperlink to the stored video clip that shows the violation in progress.

16. A method for monitoring vehicle violations at a location, the method comprising the steps of:
specifying a traffic violation that may occur at the location;
providing a video camera at the location;
using a processor to monitor information from the location to determine when a traffic violation has likely occurred; and
when a violation has likely occurred, presenting video of the violation occurring to a system operator.

17. The method of claim 16 further including the step of confirming via the presented video that a violation has occurred and issuing a citation when a violation has occurred.

18. The method of claim 16 wherein equipment used to present the video is used to present other information in addition to the video and wherein the method further includes the step of, when a violation likely occurs while other information is being presented by the equipment, replacing at least a subset of the other information with the video.

19. The method of claim 16 wherein the step of specifying a traffic violation that may occur at the location includes specifying traffic violations that may occur at a plurality of different locations, the step of providing a video camera at the location includes providing a video camera at each of the plurality of locations, the step of using a processor to monitor information from the location to determine when a traffic violation has likely occurred includes using a processor to monitor information from each of the plurality of locations and, the step of presenting video includes the step of, when a violation has likely occurred at any of the plurality of locations, presenting video of the violation occurring to a system operator.

20. The method of claim 16 wherein, prior to the occurrence of a violation, the method includes presenting essentially real time video of at least a subset of the information recorded by the video cameras at the plurality of different locations to the operator for observance.

21. The method of claim 20 wherein the equipment used to present the video includes at least one screen and the step of presenting real time video includes, for each location, providing video on at least one of the screens.

22. The method of claim 21 wherein one of the screens is a primary screen and wherein the step of presenting the video of a likely violation includes presenting the video via the primary screen.

23. The method of claim 16 further including activating an alarm proximate the operator when a violation has likely occurred.

24. The method of claim 23 wherein the alarm is one of an audible alarm and a visual alarm.

25. The method of claim 16 further including the step of confirming via the video that a violation has occurred.

26. The method of claim 25 further including the step of providing a confirming input device for the operator to confirm when a violation has occurred.

27. The method of claim 26 further including the step of monitoring the input device for confirmation from the operator and, when the operator confirms that a violation has occurred, generating a citation consistent with the violation that occurred.

28. The method of claim 27 wherein the citation indicates that the operator witnessed the violation.

29. The method of claim 27 further including the step of, when the operator confirms that a violation has occurred, storing a video clip that includes the violation for subsequent use.

30. The method of claim 16 wherein the location is a railroad crossing and the violation specified is an illegal crossing.

31. The method of claim 16 wherein the step of using a processor to monitor includes using the processor to analyze video information from the location.

32. The method of claim 31 wherein the step of using a processor to monitor includes sensing the status of other information in addition to the video information at the location and using both the video information and the other information to determine if a violation has likely occurred.

33. The method of claim 32 wherein the location is a railroad crossing including crossing lights that flash to indicate that traffic should halt and wherein the other information includes the status of the crossing lights.

34. An assembly for monitoring vehicle violations at a railroad crossing, the assembly comprising:
a video camera at the crossing;
a video display screen;
an input interface;
a processor receiving information from the railroad crossing and programmed to perform the steps of:
determining when a traffic violation has likely occurred;
when a violation has likely occurred, presenting video from the camera of the violation occurring to a system operator via the display screen; and
monitoring the input interface for an indication confirming that a violation has occurred.

35. The assembly of claim 34 further including a database, the processor programmed to perform the step of, when a violation is confirmed, storing a video clip of the violation in the database.

36. The assembly of claim 34 wherein the processor is further programmed to perform the step of, when a violation is confirmed, provide an image of a citation via the screen for the operator to observe.

37. The assembly of claim 36 further including a printer, the processor further programmed to perform the step of, when a violation is confirmed, printing a citation via the printer.

38. The assembly of claim 36 wherein the citation indicates the identity of the operator.

39. The assembly of claim 35 further including a printer, the processor further programmed to perform the step of, when a violation is confirmed, print a citation via the printer.
